(19) United States
(12) Patent Application Publication
(10) Pub. No.: US 2020/0346432 A1
(43) Pub. Date: Nov. 5, 2020

(54) Bonding Method

(71) Applicant: Marelli Corporation, Saitama-shi , Saitama (JP)

(72) Inventors: Teruyoshi Mihara, Saitama-shi, Saitama (JP); Tomihito Hashimoto, Saitama-shi, Saitama (JP); Yuusuke Nakata, Saitama-shi, Saitama (JP); Motoki Kurasawa, Saitama-shi, Saitama (JP)

(21) Appl. No.: 16/632,733

(22) PCT Filed: Jul. 4, 2018
(86) PCT No.: PCT/JP2018/025395

§ 371 Date: Jan. 21, 2020

(30) Foreign Application Priority Data
Jul. 24, 2017 (JP) 2017-142962

(51) Int. Cl. B32B 7/025; B32B 15/04; H01M 8/12; H01M 8/24; H01M 8/0247

(52) U.S. Cl. CPC B32B 7/025; B32B 15/04; H01M 2008/1293; H01M 8/24; H01M 8/0247; H01M 8/12

(57) ABSTRACT

A bonding method in which more variety of materials can be bonded than a conventional anodic bonding method includes: a disposing step of disposing an oxygen ion conductor and a bonded material to be bonded to the oxygen ion conductor such that they are brought in contact with each other; a connecting step of connecting the oxygen ion conductor to a negative side of a voltage application device and connecting the bonded material to a positive side of the voltage application device; and a voltage applying step of applying a voltage between the oxygen ion conductor and the bonded material so as to bond the oxygen ion conductor and the bonded material, wherein abutting surfaces of the oxygen ion conductor and the bonded material are processed such that they are in close contact with each other.

### CROSS-REFERENCE TO RELATED APPLICATION(S)

This application claims priority to Japanese Application Patent Serial No. 2017-142962, filed Jul. 24, 2017, the entire disclosure of which is hereby incorporated by reference.

### TECHNICAL FIELD

The present invention relates to a bonding method.

### BACKGROUND

One of known methods for bonding materials by electrochemical reaction is an anodic bonding method (see, for example, JP2007083436 (A)). The anodic bonding method is a method in which glass and bonded material are brought into contact with each other, and a direct current (DC) voltage is applied between the bonded material side as an anode and the glass side as a cathode to bond them.

### SUMMARY

Materials can be firmly bonded to each other by the above described anodic bonding method. However, the materials to be bonded are limited such as between glass and metal or semiconductor, and its application is limited.

The present invention has been made in consideration of the above described problem, and an objective thereof is to provide a bonding method by which more variety of materials can be bonded than those bonded by a conventional anodic bonding method.

A bonding method according to a first aspect to solve the above described problem is a method including:

a disposing step of disposing an oxygen ion conductor and a bonded material to be bonded to the oxygen ion conductor such that they are brought into contact with each other;

a connecting step of connecting the oxygen ion conductor to a negative side of a voltage application device and connecting the bonded material to a positive side of the voltage application device; and

a voltage applying step of applying a voltage between the oxygen ion conductor and the bonded material to bond the oxygen ion conductor and the bonded material, wherein

abutting surfaces of the oxygen ion conductor and the bonded material are processed such that the oxygen ion conductor and the bonded material are in close contact with each other.

According to the invention, compared to a conventional anodic bonding method, more variety of materials can be bonded.

### BRIEF DESCRIPTION OF THE DRAWINGS

In the accompanying drawings:

FIG. 1 is a flow chart of a bonding method according to the present invention;

FIG. 2 is a diagram illustrating a method for bonding an oxygen ion conductor and a bonded material;

FIGS. 3A to 3D are diagrams each illustrating an example of bonding the oxygen ion conductor and two metals;

FIGS. 4A to 4D are diagrams each illustrating an example of connecting two pipes through an oxygen ion conductor packing;

FIGS. 5A to 5E are diagrams each illustrating an example of connecting two pipes by using a bonding seal tape;

FIG. 6 is a diagram illustrating a single cell structure of Solid Oxide Fuel Cell (SOFC);

FIGS. 7A to 7C are diagrams each illustrating an example of producing a cell stack; and

FIGS. 8A to 8C are diagrams each illustrating an example of producing another cell stack.

### DETAILED DESCRIPTION

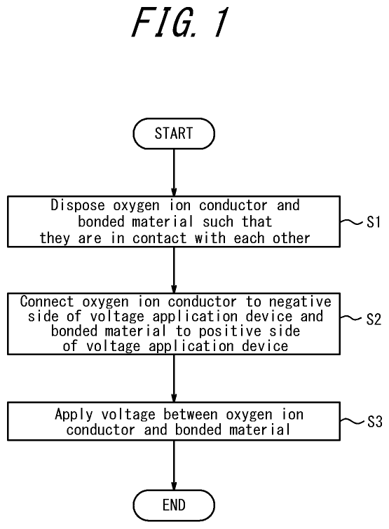

A bonding method according to the present invention will be described below with reference to the accompanying drawings. FIG. 1 is a flow chart of the bonding method according to the present invention. The bonding method according to the present invention includes a disposing step (step Si) of disposing an oxygen ion conductor and a bonded material to be bonded to the oxygen ion conductor such that they are brought into contact with each other; a connecting step (step S2) of connecting the oxygen ion conductor to a negative side of a voltage application device and connecting the bonded material to a positive side of the voltage application device; and a voltage applying step (step S3) of applying a DC voltage between the oxygen ion conductor and the bonded material to bond the oxygen ion conductor and the bonded material, wherein abutting surfaces of the oxygen ion conductor and the bonded material are processed such that the oxygen ion conductor and the bonded material are in close contact with each other.

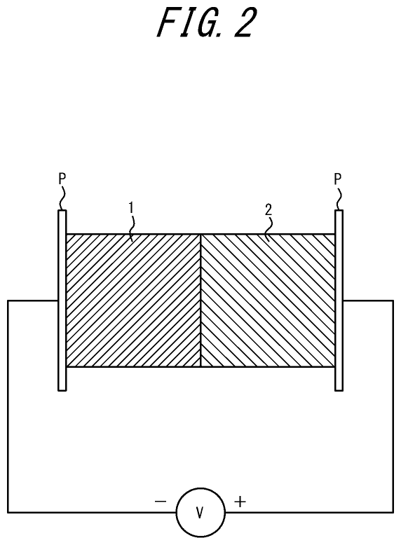

In order to establish a bonding method by which more variety of materials can be bonded than a conventional bonding method, the inventors of the present invention have tried to bond various materials under various conditions. As a result they found that, as illustrated in FIG. 2, the oxygen ion conductor 1 and the bonded material 2 are firmly bonded to each other when the oxygen ion conductor 1 and the bonded material 2 are disposed such that they are in contact with each other, the oxygen ion conductor 1 is connected to a negative side of a voltage application device V and the bonded material 2 is connected to a positive side of the voltage application device V, and a DC voltage is applied thereto.

The above described firm bonding is formed because when a voltage is applied between the oxygen ion conductor 1 and the bonded material 2, oxidation reactions represented by the following formulae (1) to (3) may occur between the oxygen ion conductor (X-O) 1 and the bonded material 2.

X−O+O²⁻+M □□X−O₂−M+2e (1)

O²⁻+M□M−O+2e (2)

X−O+O²⁻+M−O□X−O₃−M+2e (3)

It is considered that, on the abutting surfaces of the oxygen ion conductor (X−O) 1 and the bonded material (M) 2, oxygen ions entered into oxygen hole positions release electrons due to the above described oxidation reaction, and a new firm bonding (X−O₃−M) is formed with the bonded material (M) 2 and the oxygen ion conductor (X−O) 1, as a result a firm bonding is formed on the abutting surfaces.

Further, in the present invention, the abutting surfaces of the oxygen ion conductor 1 and the bonded material 2 are processed such that they are in close contact with each other before the disposing step is performed, which increases a bonding strength between the oxygen ion conductor 1 and the bonded material 2. In this manner, according to the present invention, more variety of materials can be firmly bonded compared to a conventional anodic bonding method. Each step of the present invention will be described below.

First, in step S1, the oxygen ion conductor 1 and the bonded material 2 are disposed such that they are in contact with each other (disposing step). For example, as illustrated in FIG. 2, the oxygen ion conductor 1 and the bonded material 2 are brought into contact with each other.

The oxygen ion conductor 1 is a layer through which oxygen ions can pass and forms bonding with the bonded material 2 by the bonding method according to the present invention. Although the material of the oxygen ion conductor 1 is not particularly limited as long as it allows oxygen ions to pass therethrough, it may preferably be an oxide-ion conductor. For example, stabilized zirconia doped with Y₂O₃ (YSZ), neodymium oxide (Nd₂O₃), samarium (Sm₂O₃), gadolinium (Gd₂O₃), scandia (Sc₂O₃) and the like may be used. Further, bismuth oxide (Bi₂O₃), cerium oxide (CeO), zirconium oxide (ZrO₂), lanthanum gallate oxide (LaGaO₃), barium indium oxide (Ba₂In₂O₅), lanthanum nickel oxide (La₂NiO₄), nickel potassium fluoride (K₂NiF₄) and the like may also be used.

It is to be noted that the material of the oxygen ion conductor 1 is not limited to the above described materials, and other known oxygen ion conductor materials may be used. A single kind of material or a combination of some kinds of materials may be used.

Typically, the above described oxygen ion conductor 1 obtained by a hot-press method can be used. In the method, raw material powder is mixed with organic binder. The resulting mixture is stretched thin by applying a pressure and is subjected to pressure sintering in a high-temperature furnace. Even thinner oxygen ion conductor 1 can be produced by a sol-gel method.

The bonded material 2 is a member to be bonded with the oxygen ion conductor 1 by the bonding method according to the present invention. The bonded material 2 is a material capable of forming a stabilized covalent bonding with oxygen, and may preferably have electron conductivity, which allows the bonded material 2 to be efficiently oxidized.

Materials that have electron conductivity and provide stable bonding with oxygen include, for example, metals such as Ni (nickel), Ti (titanium), W (tungsten) and the like. Other than metals, n-type semiconductors may be used as a material that has similar properties. In n-type semiconductors, donor level electrons are excited into the conduction band and exhibit electronic conduction at relatively low temperatures. For example, Si and SiC can be used as such semiconductors.

Furthermore, intrinsic semiconductors having electron conductivity at a temperature when bonding can be used as a material for the bonded material 2. In particular, intrinsic semiconductors having a small band gap can be used. Such intrinsic semiconductors have high electron conductivity when valence band electrons are excited into the conduction band at a temperature when bonding. As such intrinsic semiconductors, Si may be used when the working temperature is 400□C or more, for example. Conduction type at room temperatures can be p-type or n-type.

Further, even if the bonded material 2 is an insulating oxide film having no electron conductivity, the bonded material 2 can be made electron-conductive by forming the bonded material 2 thin such that electrons can pass through (tunnel) the bonded material 2 in the thickness direction. The specific thickness of the bonded material 2 in this case cannot be defined unconditionally because the thickness depends on the material forming the bonded material 2. However, for example, in the case where the bonded material 2 is made of SiO₂, if its thickness is effectively about 50 Å, electrons can pass therethrough in its thickness direction. In this case, the wording of “effectively” is used because the effective barrier thickness of the oxide film changes depending on the electric field. It is well known that the higher the applied voltage, the thinner the effective barrier through which electrons can pass. That is, when the voltage is extremely low (about 1V), a current flows if the thickness of the insulator is about 50 Å, but does not flow if the thickness is 100 Å. However, when the voltage is increased, the electric field of the insulator rises, a phenomenon called “Fowler-Nordheim Tunneling” occurs, and a current passes through the insulator, which indicates that the effective thickness of the insulator is reduced to about 50 Å.

In the present invention, when a high voltage of hundreds of Volts is applied, the abutting surfaces of the oxygen ion conductor 1 and the bonded material 2 are firmly attracted to each other by electrostatic attraction. When the abutting surfaces come close to each other up to about a distance between atoms, a covalent bonding is formed between atoms at abutting surfaces by the above described electrochemical reaction. Therefore the flatness of the surface to be bonded is important, and it is desirable that the surface is mirror-finished as far as possible. Specifically, it is preferable that the abutting surfaces of the oxygen ion conductor 1 and the bonded material 2 are finished flat by the mirror polishing or at least one of the oxygen ion conductor 1 and the bonded material 2 is made thin such that they are in close contact with each other. In this manner the bonding strength between the oxygen ion conductor 1 and the bonded material 2 can be increased.

Next, in step S2, the oxygen ion conductor 1 is connected to the negative side of the voltage application device V and the bonded material 2 is connected to the positive side of the voltage application device V (connecting step). For example, as illustrated in FIG. 2, the oxygen ion conductor 1 is brought into contact with an electrode plate P that is connected to the negative electrode and the surface of the bonded material 2 is brought into contact with the electrode plate P that is connected to the positive electrode.

It is to be noted that, in this connecting step, the oxygen ion conductor 1 and the bonded material 2 are not intended to be “directly” connected to the negative side of the voltage application device V and the positive side of the voltage application device V, respectively, and it is intended that, in step S3 described below, they are connected such that a voltage is applied therebetween in a state where the potential of the bonded material 2 is higher than that of the oxygen ion conductor 1.

Subsequently, in step S3, a DC current is applied between the oxygen ion conductor 1 and the bonded material 2 (voltage applying step). Specifically, as illustrated in FIG. 2, a DC voltage is applied between the electrode plate P on the positive side and the electrode plate P on the negative side while the oxygen ion conductor 1 and the bonded material 2 are heated. The oxygen ion conductivity of the oxygen ion conductor 1 increases as the temperature rises, which allows the oxygen ion conductor 1 to flow a current therethrough. In this manner the oxygen ion conductor 1 and the bonded material 2 are bonded to each other.

Because the resistance value of the oxygen ion conductor 1 changes according to the working temperature, a voltage applied between the oxygen ion conductor 1 and the bonded material 2 is set to an optimum range according to the temperature. An optimum voltage is chosen according to the application in consideration of material properties of the oxygen ion conductor 1 and operating conditions after bonding. When the working temperature and the voltage are extremely low, the oxygen ion conduction current of the oxygen ion conductor 1 is reduced, and the time required for bonding formation is increased. On the other hand, when the temperature is high, although the time required for bonding formation is shortened, a residual stress after bonding is increased, which is inappropriate in terms of durability. When the voltage is extremely high, electrons are released to the portions other than the bonding portion, which makes bonding to be difficult. Typically, it is preferable that an optimum value is chosen within a range from 50V or more to 500V or less under the temperature condition from 300° C. or more to 500° C. or less. In this manner, the oxygen ion conductor 1 and the bonded material 2 can be bonded more firmly.

Next, time to apply a voltage between the oxygen ion conductor 1 and the bonded material 2 will be described. On the contact surface between an electrode plate P on the negative side and the oxygen ion conductor 1, oxygen in the air receives electrons from the electrode plate P and forms oxygen ions. The produced oxygen ions migrate through the oxygen ion conductor 1, deliver electrons to the bonded material 2 at the interface with the bonded material 2, and form firm covalent bonding with atoms forming the oxygen ion conductor 1 and the bonded material 2. In this manner, the bonded material 2 and the oxygen ion conductor 1 are chemically bonded to each other. In this case, a current indicates an increasing trend while oxygen ions are fed and a bond forming area of the bonded material 2 and the oxygen ion conductor 1 expands. When bonding is almost finished, a current starts decreasing. It is preferable that the point in time when the current starts decreasing would be an indication of stop applying a voltage. In this manner, the oxygen ion conductor 1 and the bonded material 2 can be firmly bonded to each other over the entire bonding surface.

It is to be noted that, after the (DC) voltage applying step of step S3, it is preferable that an alternating current (AC) voltage is applied between the oxygen ion conductor 1 and the bonded material 2 (AC voltage applying step). When the above described (DC) voltage applying step is performed only once, oxidation of the bonded material 2 may be incomplete. Thus, after the voltage applying step, an AC voltage is applied between the oxygen ion conductor 1 and the bonded material 2. When positive and reverse voltages are repeatedly applied, a portion where oxidation is incomplete is once reduced and is oxidized again. As a result, unreacted, unbound or incompletely arranged atoms at the bonding portion between the oxygen ion conductor 1 and the bonded material 2 can be transited into more stable state. In this manner more firm bonding can be obtained between the oxygen ion conductor 1 and the bonded material 2.

In the above described AC voltage applying step, it is preferable that the AC voltage frequency is lower than that corresponding to the time required for an incomplete bonding of the bonding portion to cause an oxidation-reduction reaction.

In this manner the oxygen ion conductor 1 and the bonded material 2 can be bonded to each other. According to the bonding method of the present invention, more variety of materials can be firmly bonded compared to a conventional anodic bonding method.

Further, because the bonded material 2 has electron conductivity, the bonded material 2 can be efficiently oxidized. The bonded material 2 having electron conductivity as described above can be formed by either an n-type oxide semiconductor or an intrinsic semiconductor having electron conductivity at a temperature when bonding. Further, even if the bonded material 2 is an oxide film of an insulator having no electron conductivity, the bonded material 2 can have electron conductivity by reducing the thickness of the bonded material 2 to an extent that allows electrons to pass therethrough in its thickness direction.

Further, because the oxygen ion conductor 1 is an oxide-ion conductor, O²⁻ ions can be migrated favorably through the oxygen ion conductor 1 to the anode side and be released.

Further, after the (DC) voltage applying step, an AC voltage is applied between the oxygen ion conductor 1 and the bonded material 2. As a result a portion where oxidation is incomplete is reduced once and is oxidized again, and unreacted, unbound or incompletely arranged atoms at the bonding portion between the oxygen ion conductor 1 and the bonded material 2 can be transited into more stable state. In this manner more firm bonding can be obtained between the oxygen ion conductor 1 and the bonded material 2.

### EXAMPLES

Hereinafter some examples according to the present invention will be described in more detail. However the present invention is not limited thereto.

### Example 1

### Bonding of Two Metals

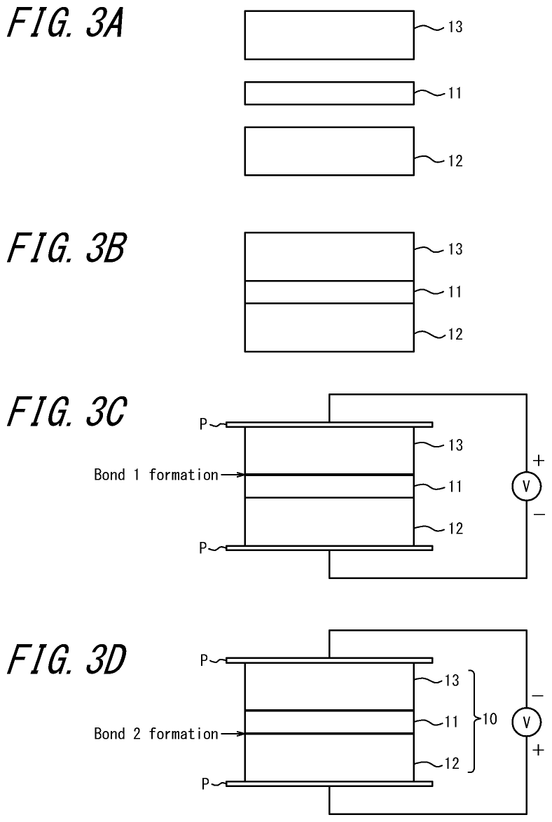

In this example, two metals are bonded. FIG. 3A illustrates an oxygen ion conductor 11 and two metals 12 and 13 to be bonded. These metals 12 and 13 are disposed on both surfaces of the oxygen ion conductor 11 as illustrated in FIG. 3B.

Next, as illustrated in FIG. 3C, the metal 13 is connected to an electrode plate P on the positive side of a voltage application device V and the bonded material 12 is connected to an electrode plate P on the negative side. After that a DC voltage is applied between the metals 12 and 13 while the oxygen ion conductor 11 and the metals 12 and 13 are heated. In this manner a bond (bond 1) is formed between the oxygen ion conductor 11 and the metal 13.

Subsequently, as illustrated in FIG. 3D, a polarity of the voltage applied between the metals 12 and 13 is reversed, and a DC voltage is applied between the metals 12 and 13 while the oxygen ion conductor 11 and the metals 12 and 13 are heated. As a result a bond (bond 2) is formed between the oxygen ion conductor 11 and the metal 12. In this manner, the oxygen ion conductor 11 and the two metals 12 and 13 are firmly bonded by applying a DC voltage twice, and a stack 10 can be formed.

### Example 2

### Connection of Two Pipes Through Packing

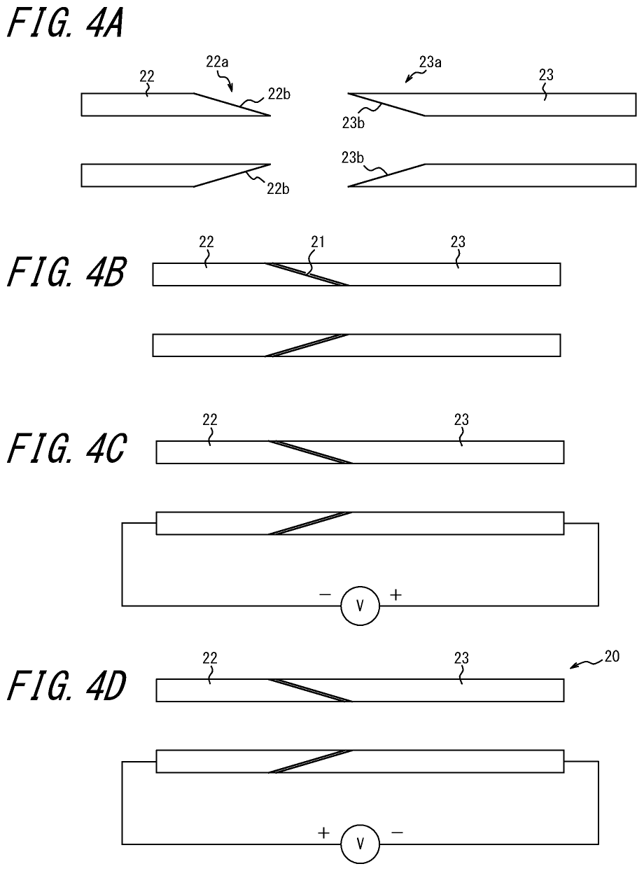

In this example, two pipes for high-temperature gas or liquid to which resin or rubber packing cannot be used are connected to each other. FIG. 4A illustrates cross-sections of two pipes 22 and 23 to be connected to each other. As illustrated therein, an end 22a of one pipe 22 is tapered toward its tip. On the other hand, an end 23a of the other pipe 23 is expanded toward its tip.

The end 22a of the pipe 22 and the end 23a of the pipe 23 are connected to each other through a packing 21 of oxygen ion conductor as illustrated in FIG. 4B. In this manner an outer surface 22b of the end 22a of the pipe 22 is in contact with the packing 21, and an inner surface 23b of the end 23a of the pipe 23 is in contact with the packing 21.

Further, as illustrated in FIG. 4C, the pipe 22 is connected to the negative side of the voltage application device V and the pipe 23 is connected to the positive side, and a DC voltage is applied between the pipes 22 and 23 while the packing 21 and the pipes 22 and 23 are heated entirely. In this manner, the packing 21 and the inner surface 23b of the end 23a of the pipe 23 are firmly bonded to each other.

Subsequently, as illustrated in FIG. 4B, the polarity of the voltage applied between the pipes 22 and 23 is reversed, and a DC voltage is applied between the pipes 22 and 23 while the packing 21 and the pipes 22 and 23 are heated entirely. In this manner, the packing 21 and the outer surface 22b of the end 22a of the pipe 22 are firmly bonded to each other. As a result the pipes 22 and 23 are integrated and a connected pipe 20 illustrated in FIG. 4D can be obtained.

### Example 3

### Connection of Two Pipes by Bond Sealing Tape

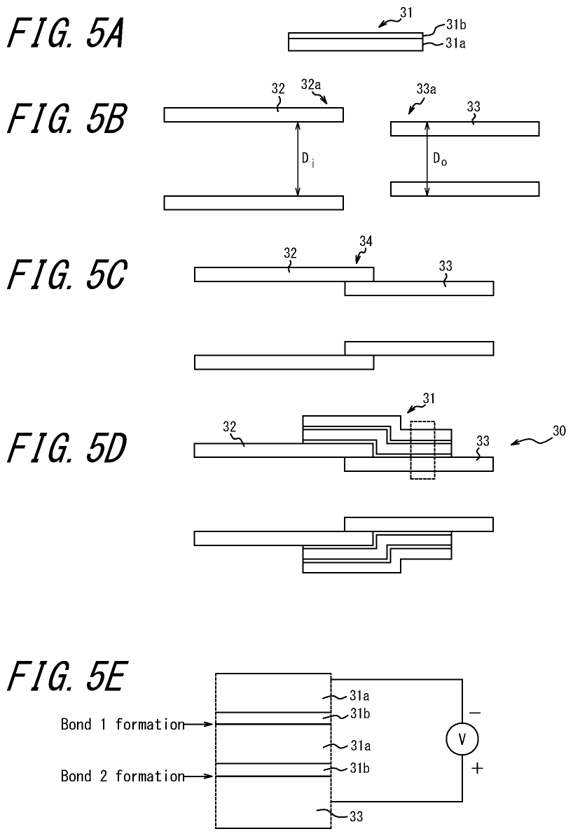

In this example, two pipes for high-temperature gas or liquid to which resin or rubber packing cannot be used are connected to each other by using a bond sealing tape having high-temperature resistance. FIG. 5A illustrates a cross-section of a bond sealing tape used for connecting two pipes to each other. This bond sealing tape 31 includes an oxygen ion conductor thin film 31b, formed by CVD or PVD method, on one surface of a metal tape material 31a having flexibility.

FIG. 5B illustrates cross-sections of two pipes 32 and 33 to be connected to each other. These pipes 32 and 33 are formed such that the inner diameter Dᵢ of the pipe 32 is almost the same as the outer diameter Dₒ of the pipe 33. As illustrated in FIG. 5C, the end 33a of the pipe 33 is inserted into the end 32a of the pipe 32 such that the pipes 32 and 33 are connected to each other.

Subsequently, as illustrated in FIG. 5D, the bond sealing tape 31 is wound around the connecting portion 34 between the pipe 32 and the pipe 33 such that at least a part of the bond sealing tape 31 is overlapped with itself. It is to be noted that, in FIG. 5D, the bond sealing tape 31 is wound twice such that it is overlapped completely. Further, the oxygen ion conductor thin film 31b is wound such that it is brought into contact with the outer surface of the pipe 33. In this manner a stack structure of the tape is formed as illustrated in FIG. 5D.

As illustrated in FIG. 5E, a metal tape material 31a on the outermost surface of a stack structure is connected to the negative side of the voltage application device V and the pipe 33 is connected to the positive side, and a DC voltage is applied between the metal tape material 31a on the outermost surface of the stack structure and the pipe 33 while the bond sealing tape 31 and the pipes 32 and 33 are heated entirely. In this manner, in the stack structure of the bond sealing tape 32, a bond 1 is formed between the metal tape 31a having heat resistance and the oxygen ion conductor thin film 31b, and a bond 2 is formed between the oxygen ion conductor thin film 31b and the pipe 33. Thus the pipes 32 and 33 are integrated. In this manner the pipes 32 and 33 are firmly connected to each other, and the pipe 30 illustrated in FIG. 5D can be obtained.

### Example 4

### Production of Solid Oxide Fuel Cell (SOFC)

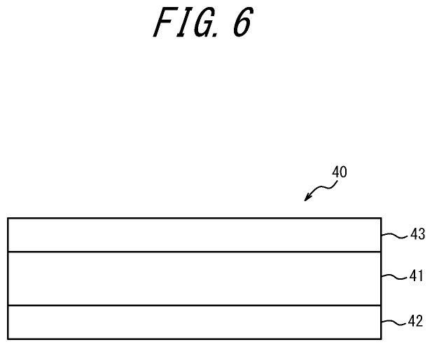

In this example, a SOFC, which is a fuel cell using a solid electrolyte is produced. FIG.6 illustrates a fuel battery cell (single cell), which is a power generation unit of SOFC. A single cell 40 illustrated in FIG. 6 is provided with an anode material 42 on one surface of the solid electrolyte layer 41 and a cathode material 43 on the other surface thereof.

The solid electrolyte layer 41 is an oxygen ion conductor such as YSZ and the like. Further, in this example, the anode material 42 is formed of an oxide material having electron conductivity such that a finally obtained single cell 40 is an oxygen ion conductor in its entirety. For example, it is formed of a mixture (cermet) of Ni and a solid electrolyte layer material. Further, the cathode material 43 is formed of an oxide material having oxygen ion/electron mixed conductivity. As the above described oxide materials, La(Sr)MnO₃, La(Sr)FeO₃, La(Sr)CoO₃, LaNiO₄ and the like can be used.

The single cell 40 illustrated in FIG. 6 can be formed by paste printing the anode material 42 on one surface of the solid electrolyte layer 41 and the cathode material 43 on the other surface thereof, and sintering the solid electrolyte layer 41. Further, the single cell 40 can also be formed by stacking, as thin films, the anode material 42, the solid electrolyte layer 41 and the cathode material 43 by PVD method. Moreover, when amorphous silicon (a-Si) and nickel (Ni) and the like are used for the anode material 42 and the cathode material 43, the anodic bonding can be used.

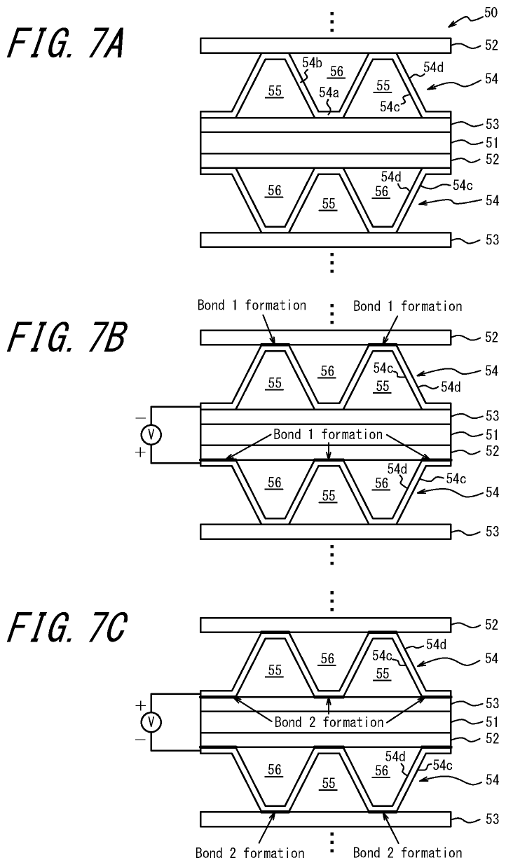

FIG. 7A illustrates a cell stack composed of a plurality of single cells stacked through separators. A cell stack 50 illustrated in FIG. 7A includes a plurality of single cells composed of a solid electrolyte layer 51, an anode material 52 and a cathode material 53, and a plurality of separators 54. In the cell stack 50, the anode material 52 acts as a fuel electrode and the cathode material 53 acts as an air electrode. The separator 54 is made of metal, includes a cross-section formed into a trapezoidal shape by press molding, and has a flat plate 54a and a standing plate 54b. Further, the anode material 52 is disposed on one surface of the solid electrolyte layer 51 and the cathode material 53 is disposed on the other surface thereof, and thus a single cell is formed. These single cells are connected in series in the stack direction and form the cell stack 50.

An oxidized gas passage 55 and a fuel gas passage 56 are formed between the solid electrolyte layer 51 and the anode material 52 or the cathode material 53 by stacking the separator 54 having a cross-section of a trapezoidal waveform shape, the solid electrolyte layer 51, the anode material 52 and the cathode material 53 to form a stack. The cell stack 50 illustrated in FIG. 7A is formed such that trapezoidal wave phases of the separators 54 facing each other across a stack of the solid electrolyte layer 51, the anode material 52 and the cathode material 53 are reversed to each other. In this manner, the fuel gas passage 56 is disposed immediately below the oxidized gas passage 55, and oxygen ions produced at the cathode material (air electrode) 53 migrate through the solid electrolyte layer 51 to the fuel gas passage 56 located immediately below and react with fuel gas. In this manner the ion conductive resistance can be reduced.

The cell stack 50 illustrated in FIG. 7A can be obtained in the following manner. First, a stack composed of the solid electrolyte layer 51, the anode material 52 and the cathode material 53 is formed. This can be formed by paste printing the anode material 52 on one surface of the solid electrolyte layer 51 and the cathode material 53 on the other surface thereof, for example, and sintering them. Further, a stack can also be formed by stacking, as thin films, the anode material 52, the solid electrolyte layer 51 and the cathode material 53 by PVD method. The materials for the solid electrolyte layer 51, the anode material 52 and the cathode material 53 can be the same as those for the single cell 40 illustrated in FIG. 6. In this manner, the resulting stack (single cell) will be an oxygen ion conductor in its entirety.

Next, the stack and the separators 54 are stacked as illustrated in FIG. 7A. Subsequently, as illustrated in FIG. 7B, the entire cathode material 53 is connected to the negative side of the voltage application device V and the entire anode material 52 is connected to the positive side thereof as illustrated in FIG. 7B while heating the whole, and a DC voltage is applied thereto. In this manner, a bond 1 is formed between the surface 54d of the separator 54 and the anode material 52. Subsequently, as illustrated in FIG. 7C, the voltage polarities are reversed, and a voltage is applied between the anode material 52 and the cathode material 53 facing each other across the solid electrolyte layer 51. As a result a bond 2 is formed between the surface 54c of the separator 54 and the cathode 53. In this manner the stack composed of the solid electrolyte layer 51, the anode material 52 and the cathode material 53 and the separator 54 are bonded, and integrated in its entirety. Thus the cell stack 50 is obtained.

The operation of the obtained cell stack 50 will be explained below. First, oxidant gas such as air is flowed through the oxidized gas passage 55 and fuel gas such as hydrogen is flowed through the fuel gas passage 56, thereafter the cell stack 50 is heated. As a result, at the cathode material (air electrode) 53, oxygen contained in oxidant gas receives electrons from an external circuit not illustrated and forms oxygen ions. The formed oxygen ions migrate to an anode material (fuel electrode) 52 through the solid electrolyte layer 51 and react with fuel gas. At the time of reaction, electrons are released and fed to an external circuit. In this manner power generation is performed.

In the above described cell stack 50, power generation is performed between the anode material 52 and the cathode material 53 facing across the solid electrolyte layer 51, and thus area utilization of the solid electrolyte layer 51 is about 100%.

### Example 5

### Production of Solid Oxide Fuel Cell (SOFC)

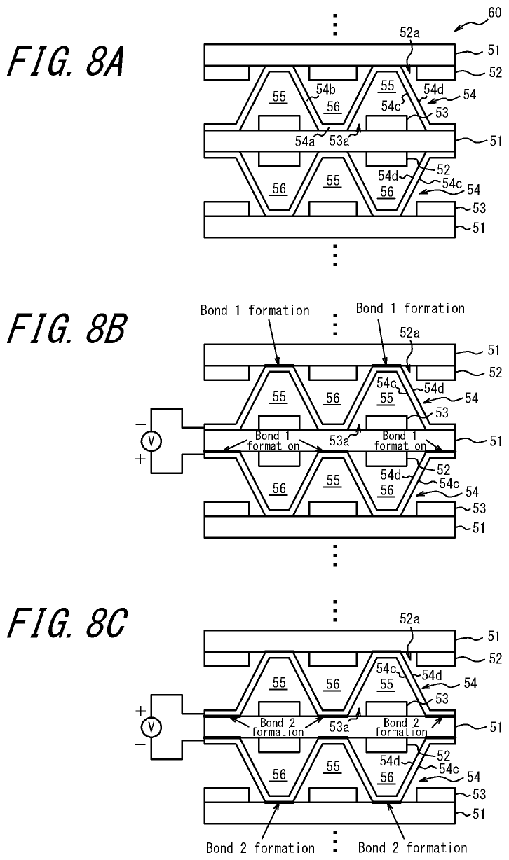

FIG. 8 illustrates a cell stack 60 having a structure similar to that illustrated in FIG. 7. In FIG. 8, the same reference signs are assigned to the structures that are the same as those of the cell stack 50 illustrated in FIG. 7. The cell stack 60 illustrated in FIG. 8 and the cell stack 50 illustrated in FIG. 7 are different in that, in the cell stack 60 illustrated in FIG. 8, each of the anode material 52 and the cathode material 53 has a plurality of holes 52a and 53a, and is directly in contact with the separator 54 and the solid electrolyte layer 51. The anode material 52 and the cathode material 53 have low denseness to obtain gas diffusivity, and extreme operating conditions in which intermittent running is repeated may cause problem with the bonding strength and sealing. In this example, the separator 54 is directly bonded to the dense solid electrolyte layer 51, and thus a firm bonding having high sealability can be achieved. In this manner durability can be improved under the above described extreme conditions.

In the case of paste printing, the above described hole 52a of the anode material 52 and the hole 53a of the cathode material 53 can be formed by applying no paste to the portions where holes are formed by using a mask. Further, in the case of PVD method, the holes 52a and 53a can be formed by photoetching after a single cell is formed.

The cell stack 60 illustrated in FIG. 8 can be produced in the same manner as the cell stack 50 illustrated in FIG. 7. That is, first, when a stack composed of the solid electrolyte layer 51, the anode material 52 and the cathode material 53, and separators are stacked, a flat plate 54a of the separator 54 is disposed in the hole 52a of the anode material 52 or the hole 53a of the cathode material 53 so as to be in contact with the solid electrolyte layer 51. Further, as with the cell stack 50 illustrated in FIG. 7, a DC voltage is applied twice between the separators 54 facing across the stack by reversing the polarity. Thus the bond 1 is formed between a surface 54d of the separator 54 and the solid electrolyte layer 51, and a bond 2 is formed between a surface 54c of the separator 54 and the solid electrolyte layer 51. In this manner, a stack composed of the solid electrolyte layer 51, the anode material 52 and the cathode material 53, and the separator 54 are bonded and integrated in its entirety, and a cell stack 60 is obtained.

In the above described cell stack 60, power generation is also performed between the anode material 52 and the cathode material 53 facing across the solid electrolyte layer 51, and thus area utilization of the solid electrolyte layer 51 is about 100%.

### REFERENCE SIGNS LIST

1, 11 oxygen ion conductor

2 bonded material

10 stack

12, 13 metal

20,22,23,30,32,33 pipe

21 packing

22a,23a,32a,33a end

22b outer surface

23b inner surface

31 bond sealing tape

31a metal tape material

31b oxygen ion conductor thin film

34 connecting portion

40 fuel battery cell (single cell)

41,51 solid electrolyte layer

42,52 anode material

43,53 cathode material

50,60 cell stack

51 solid electrolyte layer

52a,53a hole

54 separator

54a flat plate

54b standing plate

54c,54d surface of separator

55 oxidized gas passage

56 fuel gas passage

1. A bonding method, comprising:
a disposing step of disposing an oxygen ion conductor and a bonded material to be bonded to the oxygen ion conductor such that they are brought in contact with each other;
a connecting step of connecting the oxygen ion conductor to a negative side of a voltage application device and connecting the bonded material to a positive side of the voltage application device; and
a voltage applying step of applying a voltage between the oxygen ion conductor and the bonded material to bond the oxygen ion conductor and the bonded material, wherein
abutting surfaces of the oxygen ion conductor and the bonded material are processed such that the oxygen ion conductor and the bonded material are in close contact with each other.

2. The bonding method according to claim 1, wherein the bonded material has electron conductivity.

3. The bonding method according to claim 2, wherein the bonded material is composed of a metal, an n-type semiconductor, or an intrinsic semiconductor having electron conductivity at a temperature when bonding.

4. The bonding method according to claim 2, wherein the bonded material is composed of an insulating film through which electrons can pass in a thickness direction thereof.

5. The bonding method according to claim 1, wherein the oxygen ion conductor is an oxide-ion conductor.

6. The bonding method according to claim 1, wherein, in the disposing step, two bonded materials are disposed such that they are in contact with the oxygen ion conductor; and
the voltage applying step includes a first voltage applying step of applying a voltage of a first polarity between the two bonded materials to bond the oxygen ion conductor and one of the two bonded materials and a second voltage applying step of applying a voltage of a second polarity, which is reverse of the first polarity, between the two bonded materials to bond the oxygen ion conductor and the other one of the two bonded materials.

7. The bonding method according to claim 6, wherein
the bonded material is a pipe; and
in the disposing step, two pipes are disposed such that they are connected to each other through a packing composed of the oxygen ion conductor.

8. The bonding method according to claim 1, wherein the bonded material is a flexible metal tape material, and the metal tape material and a thin film composed of the oxygen ion conductor provided on one of surfaces of the metal tape material form a bond sealing tape; and
in the disposing step, after two pipes are connected by a connecting portion, the bond sealing tape is wound around the connecting portion such that at least a part of the bound sealing tape is overlapped with itself.

9. The bonding method according to claim 6, wherein
the oxygen ion conductor has a solid electrolyte layer, an anode material disposed on one of surfaces of the solid electrolyte layer and a cathode layer disposed on the other surface of the solid electrolyte layer;
the bonded material is a separator; and
the disposing step is performed such that a plurality of the oxygen ion conductors and a plurality of the separators are alternately stacked.

10. The bonding method according to claim 9, wherein
each of the anode material and the cathode material has a plurality of holes; and
the disposing step is performed such that the separator is in contact with the solid electrolyte layer at each of the holes.

11. The bonding method according to claim 1, wherein
the voltage applying step is a DC voltage applying step, and the step further includes an AC voltage applying step of applying an AC voltage between the oxygen ion conductor and the bonded material.

12. The bonding method according to claim 2, wherein the oxygen ion conductor is an oxide-ion conductor.

13. The bonding method according to claim 3, wherein the oxygen ion conductor is an oxide-ion conductor.

14. The bonding method according to claim 4, wherein the oxygen ion conductor is an oxide-ion conductor.
